(19) United States
(12) Patent Application Publication
(10) Pub. No.: US 2008/0320463 A1
(43) Pub. Date: Dec. 25, 2008

(54) System, method and computer-readable medium for enhanced user deletion of software from a computer

(76) Inventors: Harold Lee Peterson, Scotts Valley, CA (US); Nick Labosky, San Jose, CA (US)

Correspondence Address: PATRICK REILLY, P.O. BOX 7218, SANTA CRUZ, CA, 95061-7218, US

(21) Appl. No.: 11/821,779

(22) Filed: Jun. 25, 2007

(51) Int. Cl. G06F 9/44

(52) U.S. Cl. 717/168

(57) ABSTRACT

A system, method and computer-readable medium are provided for deleting software from a computational device, such as a personal computer, a cell phone or a personal digital assistant. The invented method includes (a.) providing a visual representation of application icons associated with a demo center icon, each icon having a one-to-one correspondence with at least one software application; (b.) enabling a user to select an icon; and (c.) directing the at least one computational device to delete the software application associated with the selected icon from the computational device. The software application may be provided in an operational state of (1.) being incomplete and requiring additional software encoded instructions to be read into the computer in order to at least partially function; (2.) being complete and enabled to operate only within a trial period; or (3.) being complete and requiring a purchase for operation or use.

### FIELD OF THE INVENTION

The present invention relates to information technology that enables the deletion of software. The present invention more particularly relates to information technology systems and methods that comprise or provide methods to delete software from consumer electronics devices.

### BACKGROUND OF THE INVENTION

A typical purchaser's satisfaction with a consumer electronics device can be significantly affected by the initial set-up experience with that device. Moreover, the out-of-the-box set-up experience of a newly purchased personal computer, digital telephone or personal digital assistant can therefore significantly affect the brand equity of the equipment manufacturer or marketer. The purchaser of a consumer personal computer, or “PC”, is often faced with the task of experiencing undesired marketing and promotional experiences when doing an initial set-up of a newly purchased PC. These user experiences can lead to consumer dissatisfaction, and can create a disincentive in the mind of some consumers to purchase again from a manufacturer or brand name supplier of a PC that delivered the undesired software marketing and promotional experience.

Many consumer electronics manufacturers and marketers derive a revenue source from including additional software and offers for sale of software products in part or in full with the device as delivered to the purchaser. The additional revenue may be provided by the marketers of the additional software, which is bundled in with the device for promotional purposes or in an attempt to sell a software program or a service offering. The additional software may include one or more software applications, demonstration software programs, software encoded offers for sale, and/or marketing information. Furthermore, the additional software may be provided in whole or in part, and/or may comprise access to an Internet service or web service.

The consumer experience in dealing with unrequested software and promotional experiences can be particularly annoying to a device purchaser when the additional software is difficult to delete from the device, persists in disrupting the purchaser's user experience, and/or undesirably uses up memory capacity of the device.

The prior art includes U.S. Pat. No. 5,960,411 that presents a method and system for placing a purchase order via a communications network; U.S. Pat. No. 6,496,875 discloses a software product uninstallation system and method; U.S. Pat. No. 7,107,366 that shows a system, method, and computer program product for uninstalling computer software; and US Patent Application Publication No. 20060282834 that presents a software uninstallation system, method and computer program product. Each and every other patent and patent application, including U.S. Pat. No. 5,960,411; U.S. Pat. No. 6,496,875; U.S. Pat. No. 7,107,366; and US Patent Application Publication No. 20060282834, mentioned in this disclosure is incorporated in its entirety and for all purposes in the present patent application and this disclosure.

There is therefore a long felt need to enable a computational device user to easily remove or delete software from a computational device.

### SUMMARY OF THE INVENTION

Towards this object and other objects that will be made obvious in light of this disclosure, the method of the present invention provides methods and computational systems that include or provide a capability to delete software from a computational device, such as a PC, a mobile digital telephone or a personal digital assistant.

The term “software application” is defined herein to include software programs, software application programs, and software enabling one or more communications network-enabled services. The term “communications network” is defined herein to include the Internet, a computer network, an intranet, and extranet, a telephony network, a digital wireless communications network, a digital wireless telephony network, and a digital electronics communications network.

Within an information technology system including or consisting of at least one computational device, a first alternate preferred embodiment of the method of the present invention, or first method, provides a computer implemented method for automatically deleting a previously loaded software application from the computational device. The first method includes (a.) providing a visual representation of a plurality of application icons and locally stored information in association with a demonstration center icon, where each icon and locally stored information has a one-to-one correspondence with at least one software application; (b.) enabling a user to select at least one icon; and (c.) directing the computational device to delete the software applications associated with selected icons from the computational device.

The software application may be initially presented to the user in an operational state selected from the group of states consisting of (1.) being incomplete and requiring additional software encoded instructions to be read into the device in order to at least partially function; (2.) being complete and enabled to operate only within a trial period; and (3.) being complete and requiring a purchase for operation or use.

The first method may include a selection of the one or more icons by using a pointing device; by clicking a button; by clicking a mouse button; by clicking a mouse button when a cursor is positioned over a predefined area of the displayed information; by depressing a key on a key pad; and/or by selection of a visually displayed indication.

A still alternate preferred embodiment of the method of the present invention provides a computational apparatus having a display means, a selection means and a control means. The display means provides a visual representation of application icons, each icon having a one-to-one correspondence with at least one software application or information. The selection means enables a user to select at least one icon. The control means directs the computer to delete software applications associated with the selected icon from the computer.

A yet alternate preferred embodiment of the method of the present invention provides a computer-readable media comprising software-encoded instructions that directs an information technology system to practice one or more aspects of one or more alternate preferred embodiments of the method of the present invention.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is schematic diagram of a computational device;

FIG. 2 is a schematic of a communications network comprising the computational device of FIG. 1;

FIG. 3 is a process diagram of a process that enables an implementation of the first method by means of-the computational device of FIG. 1;

FIG. 4 is a schematic diagram of a demonstration center registry of the computational device of FIG. 1 in accordance with the first method;

FIG. 5 is an illustration of a demo room icon displaying information of, or associated with the demonstration center registry of FIG. 4 as presented on the display screen of the computational device of FIG. 1;

FIG. 6 is a software architecture of the computational device 2 of FIG. 1;

FIG. 7 is a flowchart of an application of the first method and a single icon of the demo room icon of FIG. 5;

FIG. 8 is a flowchart of an application of the first method and the single icon of the demo room icon of FIG. 5 to delete one software application of FIGS. 1 and 6;

FIG. 9 is a flowchart of the first method applied by means of the demo room icon of FIG. 5 to delete one or more software applications of FIGS. 1 and 6; and

FIG. 10 is a flowchart of the first method applied to fetch additional software code to complete, enhance or enable a software application of FIGS. 1 and 6, and to apply a time limitation of use to the execution of a software application of FIGS. 1 and 6.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

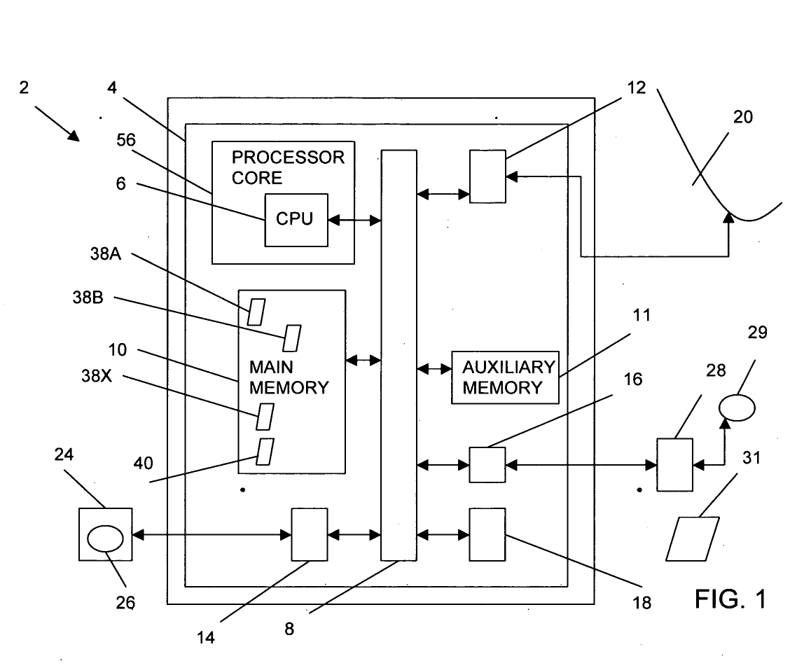

Referring now generally to the Figures, and particularly to FIG. 1, FIG. 1 is schematic diagram of a computational device 2. A host processor 4 includes a central processing unit 6, an internal communications bus 8, a main system memory 10, an auxiliary memory 11, a network interface 12, a video device interface 14, an input device interface 16, and an electronic media reader 18. The central processing unit 6, hereafter “CPU” 6 may be or comprise a PENTIUM™ microprocessor or other suitable logic-processing unit known in the art. The internal communications bus 8 bi-directionally communicatively couples the CPU 6, the main system memory 10, the network interface 12, the video device interface 14, the input device interface 16, and the electronic media reader 18. The main system memory 10, hereafter “main memory” 10, and the auxiliary memory 11 may store both data structures and executable software programs, and make the stored data structures and software executable programs available to the central processing unit 6 via the internal communications bus 8.

The main memory 10 or the auxiliary memory 11 may be or comprise an electronic solid state memory, random access memory, programmable memory, field programmable memory, a floppy disk, a flexible disk, hard disk, magnetic tape, or any suitable other magnetic medium known in the art, a CD-ROM, other suitable optical medium known in the art, a PROM, and EPROM, a FLASH-EPROM, any other suitable memory chip or cartridge known in the art, or any other suitable medium known in the art from which a computer can read machine executable instructions.

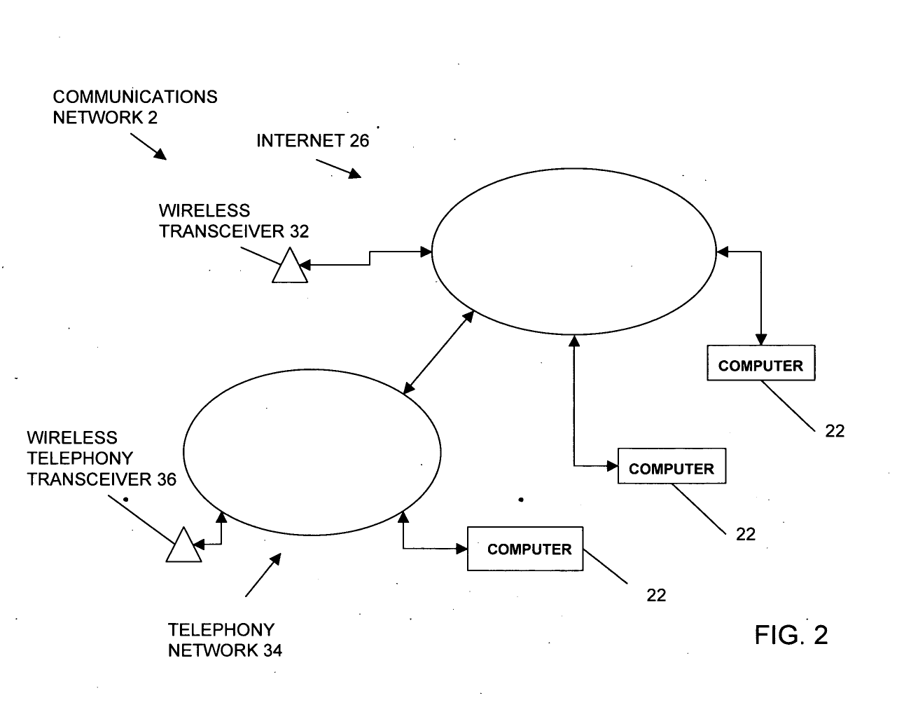

Referring now generally to the Figures and particularly to FIGS. 1 and 2, the network interface 12 is bi-directionally communicatively coupled with an electronics communications network 20 (of FIG. 2) and enables the communication of software code and message packets to and from the computational device 2 and a plurality of network computers 22 of the communications network 20.

In a preferred embodiment of the method of the present invention, the network 20 is the Internet, and more specifically, the World Wide Web portion thereof; The various computational devices 2 computers 22 thereby support the protocols for FTP, and HTTP, and provide for the display and rendering of HTML, VRML, or other text or interface description languages. Each computational device 20 and network computers 22 has an IP address that specifies its location on the communications network 2, thereby allowing such computers 2, 22 to communicate with each other in a conventional manner. Software files, such as executables, binaries, and text files may be identified within the various computers by universal resource locators (URLs) as known in the art.

The video device interface 14 is bi-directionally communicatively coupled with a video display device 24 and enables the visual presentation of information to be visually presented to a user via a video screen 26 of the video display device 24.

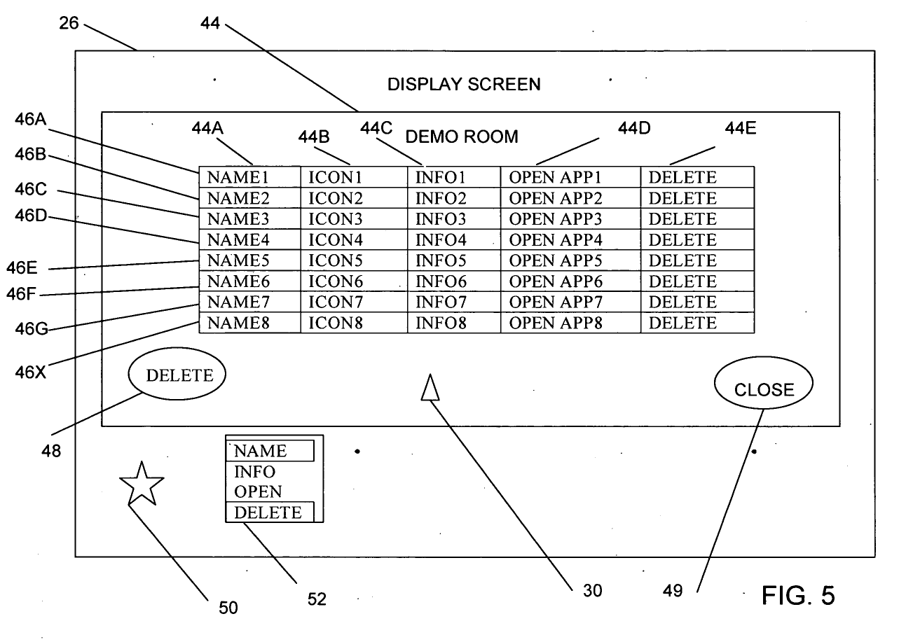

The input device interface 16 is communicatively coupled with an input device 28 and enables the user to input alphanumeric messages, commands and requests and otherwise interact with the host processor 20. The input device 28 may further comprise a point and click device 29, e.g., a computer mouse, an optical mouse, or a touch pad. The point and click device 29 is configured to enable a user to position a cursor 30 (please see FIG. 5) within the display screen 26, wherein the cursor 30 has a visible representation on the display screen 26. The computational system 2 enables the user to select and execute applications by placing the cursor 30, as positioned within a visible image of the display device 26 by the point and click device 29 and/or the input device 28, and then directing the computational device to execute a command or program associated with an icon or text image presented on the display screen 26 by manipulation of buttons of the point and click device 29 and/or one or more keys of the input device 28. The input device 28 may be or comprise a key pad have keys, wherein software selection and deletion commands to the CPU 6 may be initiated and communicated by depressing one or more keys.

The electronic media reader 18 is configured to read machine-executable instructions from a computer-readable medium 31, wherein the machine-executable instructions direct the host processor to perform one or more of the steps of the method of the present invention.

In certain alternate preferred embodiments of the method of the present invention the computational device I and one or more of the network computers 22 may be, comprise, or be comprised within, a cellular telephone, a personal digital assistant or a computer. For example, the computational system may be selected from a group of electronic devices including (1.) a Nokia Model E61™ cellular telephone marketed by Nokia Corporation of Espoo Finland; (2.) a BLACKBERRY™ wireless personal digital assistant marketed by Research-in-Motion of Waterloo, Ontario, Canada; (3.) a VAIO FS8900™ notebook computer marketed by Sony Corporation of America, of New York City, N.Y.; and (4.) POWERBOOK G4™ personal computer marketed by Apple Computer, Inc., of Cupertino, Calif. The bi-directional communicative coupling between the communications network 20 and the computational device may be accomplished by radio frequency transmissions, wherein the network interface device 12 is a wireless module and includes an antenna.

Referring now generally to the Figures, and particularly to FIG. 2, FIG. 2 is a schematic of a communications network 20 comprising the computational device 2 of FIG. 1 and a plurality of network computers 22. The network interface device 12 of computational device 2 may be a wireless interface device or module and may be configure to bi-directionally communicatively couple the computational network 2 with a wireless network transceiver 32 of the communications network 20. The communications network 2 may further comprise a telephony network 34 that includes a wireless telephony transceiver 36 configured to bi-directionally communicatively couple the computational device 2 with the telephony network 34. The communications network 2 may further comprise some or all of the Internet 36.

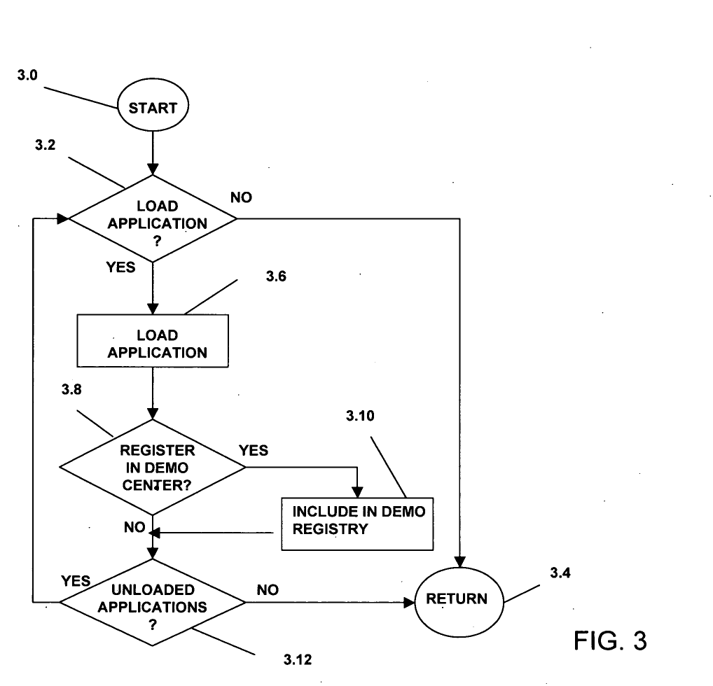

Referring now, generally to the Figures, and particularly to FIG. 3, FIG. 3 is a process diagram of the first method that may be implemented by means of the computational device of FIG. 1. In step 3.0 the computational device is powered up and its operating system is bootstrapped into enabling the processing of information and execution of one or more software applications. The computational device 2 determines in step 3.2 whether,the computational device 2 shall load an application-software 38A-38X. When the computational device 2 determines in step 3.2 to not load an application software 38A-38X, the computational device proceeds onto step 3.4 and therefrom may proceed to shut down or to perform alternate operations. Alternatively, when the computational device moves on from step 3.2 to step 3.6, a software applications 38A-38X is loaded into the main memory 10, and/or fully or partially stored in the auxiliary memory 11 of the computational device 2 via the media reader 16 and/or the network interface 12. In step 3.8 the computational device 2 determines whether information the software application 38A-38X loaded into the computational device 2 in the most recently initiated execution of step 3.6 shall be stored into a demonstration center registry 40, hereafter “demo registry” 40. In step 3.10 the computational device 2 stores information related to the application software 38A-38X loaded into the computational device 2 in the most recently initiated execution of step 3.6. In step 3.12 the computational device 2 determines whether there is at least one additional application software 38A-38X to be considered for loading into the computational device 2. When the computational device 2 determines in step 3.12 to not examine an application software 38A-38X for uploading or downloading, the computational device proceeds onto step 3.4 and may proceed therefrom to shut down or to perform alternate operations. Alternatively, when the computational device 2 determines in step 3.12 to examine an application software 38A-38X for uploading or downloading, the computational device proceeds on from step 3.12 to step 3.2.

It is understood that one or more software applications 38A-38X may be made available by the computational system 2 in an operational state of (1.) being incomplete and requiring additional software encoded instructions to be read into the computational device 2 in order to fully or at least partially function; (2.) being complete and enabled to operate only within a trial time period; and (3.) being complete and requiring a purchase for operation or use.

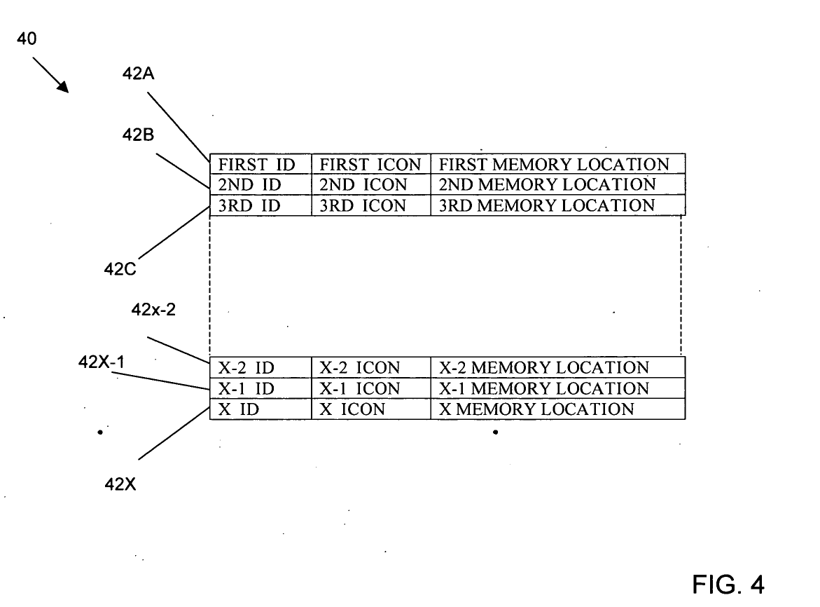

Referring now generally to the Figures, and particularly to FIG. 4, FIG. 4 is a schematic diagram of the demo registry 40 containing information in application records 42A-42X related to the software applications 38A through 38X. Each application record 42A-42X contains three data fields that contain information to a same software application 38A-38X, these three application record fields being an ID FIELD 40.A, an ICON FIELD 40.B and a MEMORY LOCATION FIELD 40.C. For example, a first application record 42A contains an identifier of a first software application 38A in its ID FIELD 40.A; its ICON FIELD 40.B contains information that enables the computational device 2 to instantiate a visual presentation of an icon associated with the first software application 38A; and its MEMORY LOCATION FIELD 40.C contains information that enables the computational device 2 to locate and erase or delete the memory locations of the computational device 2, e.g., in the main memory 10 or the auxiliary memory 11, wherein some or all the first software application 38A is stored. It is understood that deletion or erasure of a software application may be made effected by merely allowing the memory locations storing the main memory 10 to be made available for overwrite and storage of other information. It is further understood that some or all of the information stored in the demo registry 40 may be references or pointers to information stored elsewhere in the computational device, e.g., in the main memory 10 or the auxiliary memory 11, that when accessed by the controller 4 or the CPU 6 enable the computational device to visually display an icon associated with an application software 38A-38X and/or delete an application software 38A-38X from the computational device 2. Deletion commands, and selections, of a software application 38A-38X from the computational device 2 may be may be initiated by the user and communicated to the CPU 6 by depressing one or more keys of a keyboard of the input device 28.

Referring now generally to the Figures, and particularly to FIG. 5, FIG. 5 is an illustration of visual representations of information of or associated with the demo registry 40 of FIG. 4 as presented on the display screen 26 of the computational device 2. A demo room icon 44 includes a plurality of application descriptors 46A-46X that each display (1.) text images information in TEXT FIELD 44A; (2.) icon information contained in an ICON FIELD 44B; (3.) descriptive information concerning the instant software application 38A-38X in an INFO FIELD 44C; (4.) an OPEN COMMAND FIELD 44D; and a DELETE COMMAND FIELD 44E. There is a one-to-one unique correspondence between each application descriptors 46A-46X and an individual application record 42A-42X registered in the demo registry 40. For example, application descriptor 46A is generated and/or derived by the computational device 2 from information contained in the individual application record 42A; application descriptor 46X is generated and/or derived by the computational device 2 from information contained in the individual application record 42X.

One or more TEXT FIELDS 44A and the ICON FIELDS 44B may contain (1.) a visually displayed indication of a software application 38A-38X; (2.) a visual image NAME1-NAME8 or ICON1-ICON8 identifying at least one software application associated with at least one image NAME1-NAME8 or ICON1-ICON8 identifying a software application 38A-38X; and/or (3.) a visual image NAME1-NAME8 or ICON1-ICON8 comprising text identifying at least one software application associated with the image NAME1-NAME8 or ICON1-ICON8 comprising the text.

The user may direct the computational device 2 to initiate deletion or erasure of a software application 38A-38X identified by an application name image NAME1-NAME8 or an icon image ICON1-ICON8 by pointing to and selecting the DELETE COMMAND FIELD 44E of the same application descriptor 46A-46X. Alternatively, the user may direct the computational device 2 to initiate execution of a software application 38A-38X identified by an application name image NAME1-NAME8 or an icon image ICON1-ICON8 by pointing to and selecting the OPEN COMMAND FIELD 44D of the same application descriptor 46A-46X. Still additionally or alternatively, the user may direct the computational device 2 to information describing or related to a software application 38A-38X identified by an application name image NAME1-NAME8 or an icon image ICON1-ICON8 by pointing to and selecting the INFO FIELD 44C of the same application descriptor 46A-46X, wherein the displayed information referenced by the selected INFO FIELD 44C content INFO1-INFO8 is contained in or referenced by the demo registry as further discussed herein.

A delete button icon 48 is also presented within the demo room icon 44, whereby a plurality of software applications 38A-38X may be deleted or erased from the computational device 2 by first selecting each of the plurality application descriptor 46A-46X to be deleted by the user's manipulation of the cursor 30, and then point to and selecting the delete button icon, whereupon the computational device 2 is directed by the user to erase or delete each software applications 38A-38X identified by information contained in either the text images information in a TEXT FIELD 44A, or icon information contained in an ICON FIELD 44B of the selected application descriptor 46A-46X, the pointing and selecting and positioning of the cursor 30 may be accomplished by means of the input device 28 and/or the point and click device 29.

A close button icon 49 is also presented within the demo room icon 44, whereby the demo icon may be removed from the display screen 26 when selected by positioning of the cursor 30 and manipulation of the point and click device 29.

Alternatively or additionally, a single application icon 50 may be visually displayed as derived by the computational system 2 from an application record 42A-42X, whereby a specific software application 38A-38X is uniquely identified by the single application icon 50. The user may select the single application icon 50 and thereby direct the computational device 2 to visually display a drop down menu 52, by means the user may direct the computational device 2 to delete, execute, or provide information about the associated software application 38A-38X.

As an exemplary application of the demo room 44, a first application descriptor 46A may be derived from information provide within or associated with the first software application 38A. User selection of the DELETE COMMAND FIELD 44E of the first application descriptor 46A may direct the computational device 2 to delete or erase the first software application 38A. Alternatively or additionally, user selection of the application name image NAME1 of the TEXT FIELD 44A and/or the icon image ICON1 of the ICON FIELD 44B of the first application descriptor 46A followed by a selection of the delete command button 48 may direct the computational device 2 to delete or erase the first software application 38A. Furthermore, user selection of the INFO1 text of the INFO FIELD 44C of the first application descriptor 46A may direct the computational device 2 to display information derived from a first header HDR1 of the software application 38A, as discussed below, to be displayed via the video display device 28. In addition, user selection of the OPEN APP1 image of the OPEN COMMAND FIELD 44D of the first application descriptor 46A may direct the computer to initiate execution, or attempt to execute, the first software application 38A.

As an additional exemplary application of the demo room 44, a last application descriptor 46X may be derived from information provide within or associated with the last software application 38X. User selection of the DELETE COMMAND FIELD 44E of the last application descriptor 46X may direct the computational device 2 to delete or erase the last software application 38X. Alternatively or additionally, user selection of the application name image NAME8 of TEXT FIELD 44A and/or the icon image ICON8 of the ICON FIELD 44B the last application descriptor 46X followed by a selection of the delete command button 48 may direct the computational device 2 to delete or erase the last software application 38X. Furthermore, user selection of the INFO8 text of the INFO FIELD 44C of the last application descriptor 46X may direct the computational device 2 to display information derived from a last header HDRX of the last software application 38X, as discussed below, to be displayed via the video display device 28. In addition, user selection of the OPEN APP8 image of the OPEN COMMAND FIELD 44D of the last application descriptor 46X may direct the computer to initiate execution, or attempt to execute, the last software application 38X.

It is understood that one or more software applications 38A-38X may consist mostly, primarily or entirely of certain information rather than executable software code, wherein a access to the certain information may be desirable to the user and/or of economic, financial or personal value.

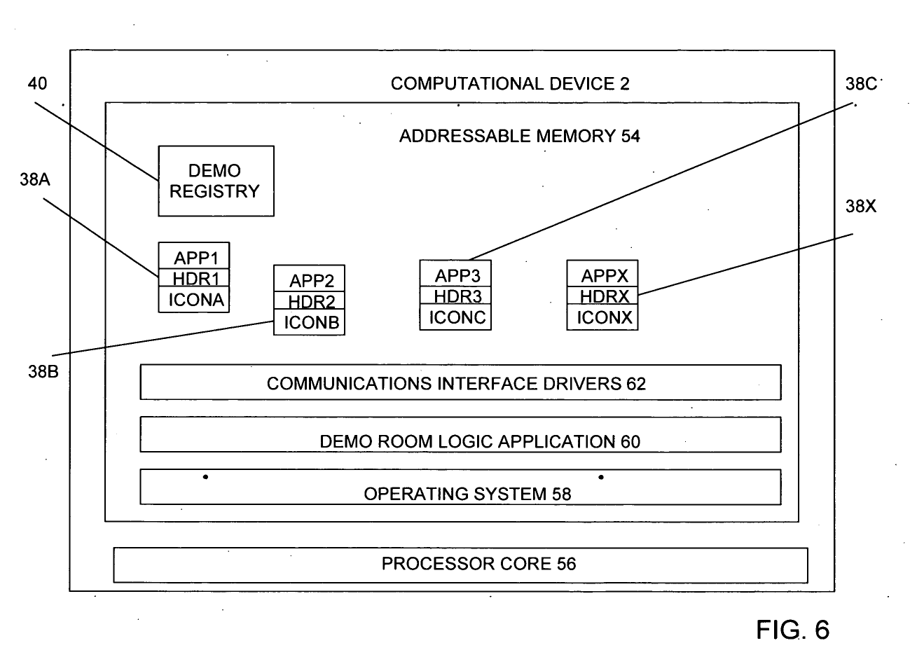

Referring now generally to the FIG. 6, and particularly to FIG. 6, FIG. 6 is a software architecture of the computational device 2 of FIG. 1. An addressable memory 54 and a processor core 56 reside within the computational device. The addressable memory 54 may comprise the main memory 10, the auxiliary memory 11, cache memory of the CPU 6, and other addressable memory locations of the computational device 2. The processor core 56 of the comprises one or more computational processors, e.g., the CPU 6. The computational device executes a conventional operating system 56; such as Windows NT.R™. from Microsoft Corp., or one of various UNIX-based operating systems, such as Sun Microsystems' Solaris 2.5. A demo room logic software application 60 provides the direction and instructions to enable the computational device to execute or support the execution of the aspects of the first method as disclosed herein and particularly as presented in FIGS. 3 and 7 through 10. A plurality of communications interface drivers 62 enables the host processor 4 to direct the network interface device 12, the video display interface device 14 and the input device interface 16, media reader 18 to (1.) upload or download software applications 38A-38X in whole or in part from the communications network 2, the computer-readable medium 31 and/or the input device 28; (2.) accept information from input device 28 and the computer-readable medium 31; and (3.) display information via the video display device 24.

One or more software applications 38A-38X may contain a header HDR1-HDRX, application software code APP1-APPX, and/or icon information ICON1-ICONX. A first header HDR1 of the first software application 38A may contain a universal resource locator, or URL, of a network computer 22 wherefrom elements of, information relating to, or information applicable by, the first software application 38A. The HDR1 may also contain offer-for-sale information specifying the price, terms and conditions of sale or licensing in accordance with which the first software application 38A may be licensed or purchased. The first header HDR1 may also contain information specifying a limited time period during which the first application software 38A may be used at no-charge or under temporary permission. The first header HDR1 may also or alternatively contain information displayed in the INFO1 of the first application descriptor 46A, as well as information that may be stored in the ID FIELD 40.A of the first application record 42A. A first icon information ICONA may contain information displayed in the first application name image NAME1 and/or the first icon image ICON1 of the first application descriptor 46A. The first icon information ICONA also may contain information stored in the ICON FIELD 40.B of the first application record 42A.

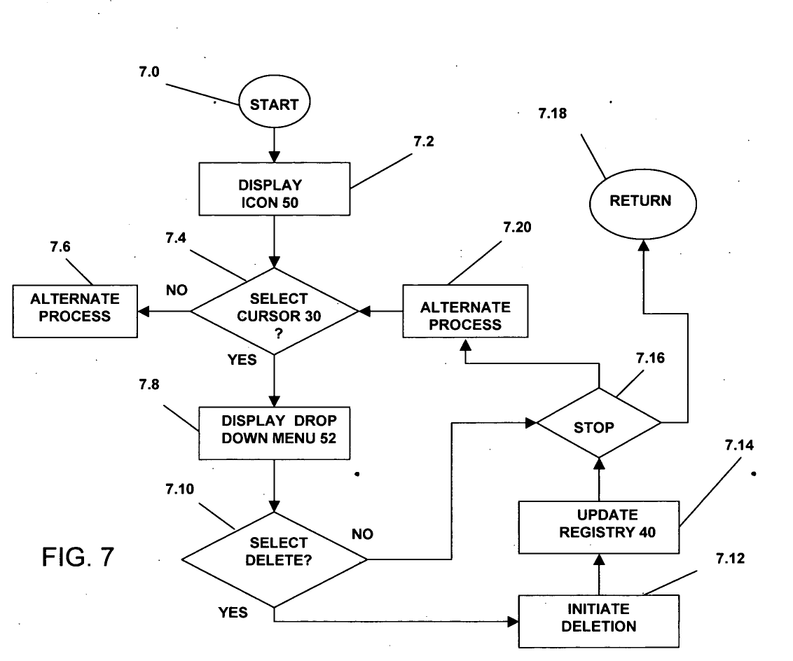

Referring now generally to the Figures and particularly to FIG. 7, FIG. 7 is a flowchart of an application of the first method and the single icon 50. In one exemplary application of the first method, the first icon 50 is associated with the first application software 38A and the image of the first icon 50 is at least partially derived from information stored in the ICON FIELD 40.B of the first application record 42A. In step 7.2 the single icon 50 is displayed on the display screen 26. In step 7.4 the computational device 2 determines whether the cursor 30 is pointing to the single icon 50, and proceeds on to alternate processes 7.6 when the cursor 50 is not determined to be pointing to or indicating a selection of the single icon 50. It is understood that the alternate process of step 7.6 may include periodically returning to step 7.2 to reexamine the cursor position and/or accept interrupts to proceed on to step 7.8. When the cursor 30 is determined in step 7.4 by the computational device 2 to be pointing to or indicating a selection of the single icon 50, the computational device 2 proceeds onto step 7.10 and displays the drop down menu 52.

In step 7.10 the computational device 2 determines whether the delete function of the drop down menu 52 is selected by the user by means of positioning the cursor 30 over the delete function text of the drop down menu 52. When the cursor 30 is determined in step 7.10 by the computational device 2 to be pointing to or indicating a selection of the delete text of the drop down menu 52, the computational device 2 proceeds onto step 7.12 and initiates deletion of the first application 38A from the addressable menu 54. Deletion of the first application 38A from the addressable menu 54 may include deleting or erasing part or all of the first application 38A from the main memory 10 and/or auxiliary memory 11. In step 7.14 the computational device updates the demo room registry 40 and erases or deletes first application record 42A and the first application descriptor 46A of the demo room icon 44. In step 7.16 the computational device 2 determines whether to proceed onto execute an alternate processes of step 7.20 or to return to other operations as per step 7.18.

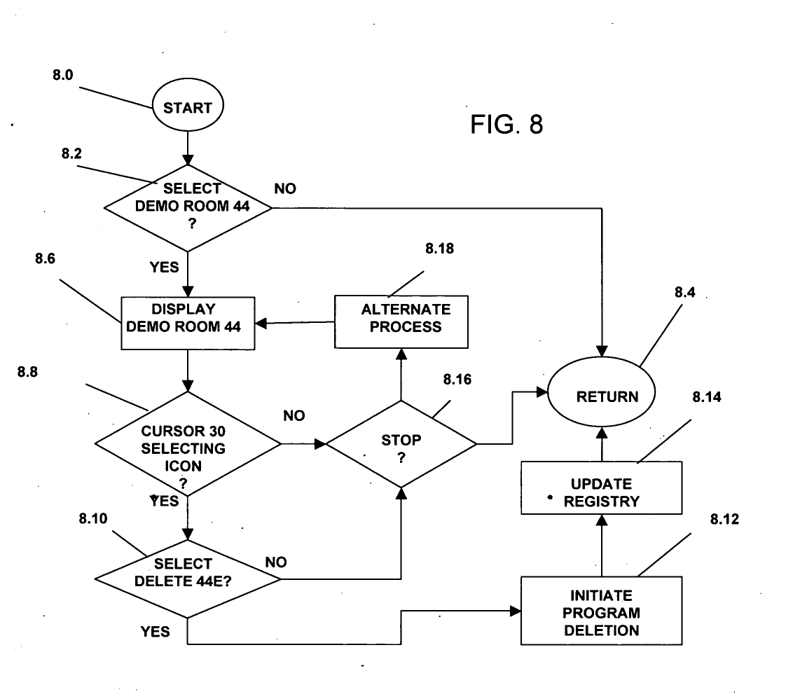

Referring now generally to the Figures and particularly to FIG. 8, Fig. is a flowchart of an application of the first method and the demo room icon 44. In step 8.2 the computational device 2 determines whether the demo room icon 44 has been selected, and proceeds onto step 8.4 and returns to, or initiates, other processes in when the cursor 30 is not determined to be pointing to or indicating a selection of the demo room icon 44. It is understood that computational device may periodically return to step 8.2 to reexamine the cursor position and/or accepting interrupts to proceed on to step 8.6. In step 8.6 the demo room icon 44 is generated by the demo room logic software application 60 and is at least partly contains and/or is derived from demo registry 40. In step 8.8 the computational device 2 determines whether an element 46A-46X, 48 or 49 of the demo room icon 44 has been selected, and if a selection has been determined, proceeds onto step 8.10 and returns to determine whether the point and click device is communication a selection of a DELETE COMMAND FIELD 44E. When a DELETE COMMAND FIELD 44E has been determined to be selected in step 8.10, the computational device proceeds onto to step 8.12 to initiate deletion of the software application 38A-38X associated with the DELETE COMMAND FIELD 44E selected in step 8.10. In step 8.14 the demo registry 40 is updated, wherein the computational device 2 erases or deletes both (1.) the application record 42A-42X associated with selected software application 38A-38X of step 8.10; and (2.) and the application descriptor 46A-46X of the demo room icon 44 associated with selected software application 38A-38X of step 8.10. Alternatively, the computational device may proceed from step 8.10 to step 8.16 when a DELETE COMMAND FIELD 44E is not determined to have been selected in step 8.10. From step 8.16 the computational device may proceed onto step 8.18 to perform alternate processes or to step 8.4.

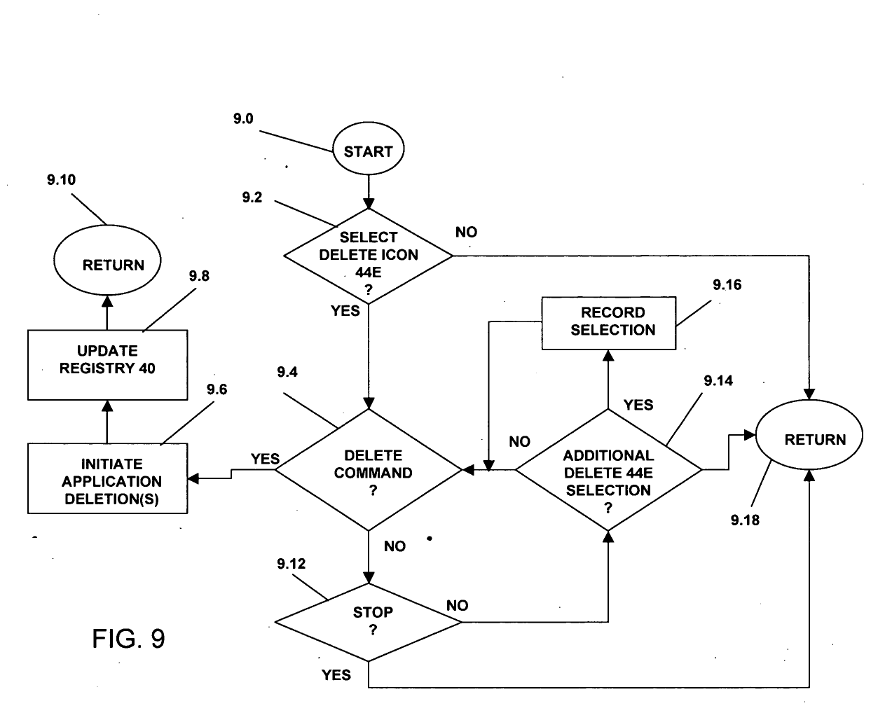

Referring now generally to the Figures and particularly to FIG. 9, FIG. 9 is a flowchart of the first method applied by means of the demo room icon 44 to delete one or more software applications 38A-38X by the actions of (1.) selection in steps 9.2 and 9.14; and (2.) directing the computational device to initiate execution of the selected software applications 38A and 38X in step 9.4. In step 9.2 a first DELETE COMMAND FIELD 44E of an application descriptor 46A-46X may be selected. In step 9.14 additional selection DELETE COMMAND FIELD 44E of an additional application descriptor 46A-46X may be determined and noted in step 9.16. The selections recorded in step 9.16 may be stored in the addressable memory 54.

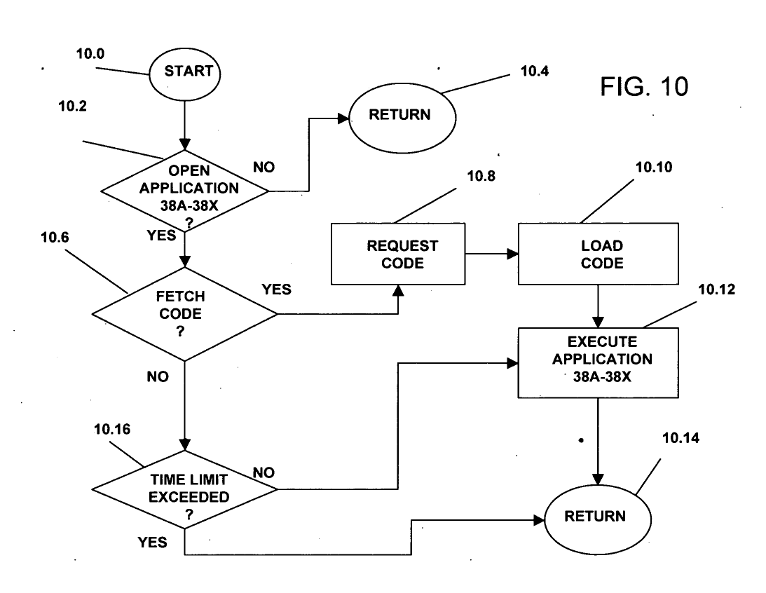

FIG. 10 is a flowchart of the first method applied to fetch additional software code to complete, enhance or enable a software application 38A-38X of FIGS. 1 and 6, and to apply a time limitation of use to the execution of a software application 38A-38X. In step 10.2 the computational device 2 determines whether to open or execute a selected software application 38A-38X, and if no to proceed onto step 10.4 and initiate or return to performing other processes. In step 10.6 the computational device 2 determines whether additional software code shall be uploaded or downloaded to complete, enhance, enable or support the execution of the software application 38A-38X of step 10.2. In step 10.8 additional software code is requested and in step 10.10 the uploaded, downloaded or otherwise fetched software code is loaded into the addressable memory 54. It is understood that software code loaded in step 10.10 may comprise of, or consist only of an encryption key, information, executable instructions, and/or executable instructions in combination with information. It is further understood that the computational device 2 may seek the additional software code from a network computer 22 of the communications network 20 addressable by a URL denoted in either (1.) a header HDR1-HDRX of the instant software application 38A-38X of step 10.2, or (2.) the addressable memory 54. In step 10.12 the software application 38A-38X of step 10.2 is executed, and in step 10.14 the computational device 2 returns to or initiates other processes.

In step 10.16 the computational engine 2 determines whether a time limitation of use is applicable to the software application of step 10.2, and if so, determines whether the time limit of use has been exceeded. If an applicable time limitation of use has been exceeded, then the computational system 2 proceeds on from step 10.16 to step 10.14. If there is no applicable time limitation of use, or no applicable time limitation of use has been exceeded, then the computational system 2 proceeds onto step 10.12 and to initiate execution of software application of step 10.2.

The computational apparatus 2 comprises the video display device 28 as display means for providing a visual representation of a plurality of application icons, as per NAME1-NAME8 and ICON1-ICON8, wherein each image NAME1-NAME8 or ICON1-ICON8 has a one-to-one correspondence with only one software application 38A-38X. The computational device further comprises the input device 28, the point and click device 29 and the input device interface as selection means for enabling a user to select at least one image NAME1-NAME8 or ICON1-ICON8 and delete software applications 38A-38X from the computational device 2.The computational devices also employs the host processor .x 4, the processor core 56, the operating system 56, the demo room logic application 60, the communications interface drivers 62 and the addressable memory 54 as control means for directing the computational device 2 to delete software applications 38A-38X.

The computer-readable media 31 comprises software-encoded instructions that direct the computational system 2 to execute one or more aspects of the method of the present invention.

The term “computer-readable medium” as used herein refers to any suitable medium known in the art that participates in providing instructions to the network for execution. Such a medium may take many forms, including but not limited to, non-volatile media, volatile media, and transmission media. Non-volatile media includes, for example, optical or magnetic disks, tapes and thumb drives. Volatile media includes dynamic memory. Transmission media includes coaxial cables, copper wire and fiber optics. Common forms of computer-readable media include, for example, a floppy disk, a flexible disk, hard disk, magnetic tape, or any other magnetic medium, a CD-ROM, any other optical medium, RAM, a PROM, and EPROM, a FLASH-EPROM, any other memory chip or cartridge, or any other suitable medium known in the art from which a computer can read machine executable instructions.

Various forms of computer readable media may be involved in carrying one or more sequences of one or more instructions to the network for execution. For example, the instructions may initially be carried on a magnetic disk of a remote computer. The remote computer can load the instructions into its dynamic solid-state electronic memory 8 and send the instructions over a telephone line using a modem. A modem local to or communicatively linked with the network can receive the data on the telephone line and use an infra-red transmitter to convert the data to an infra-red signal. An infra-red detector can receive the data carried in the infra-red signal and appropriate circuitry can provide the data to the network.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

What is claimed is:

1. Within an information technology system comprising at least one computational device, a computer implemented method for automatically deleting a previously loaded software application on the at least one computational device of the information technology system, the method comprising:
providing a visual representation of a plurality of application icons and locally stored information in association with a demo center icon, each icon and locally stored information having a one-to-one correspondence with at least one software application;
enabling a user to select at least one icon; and
directing the at least one computational device to delete the at least one software application associated with the selected icon from the at least one computational device.

2. The computer-implemented method of claim 1, wherein the at least one software application is provided in an operational state selected from the group consisting of (1.) being incomplete and requiring additional software encoded instructions to be read into the computational device in order to at least partially function; (2.) being complete and enabled to operate only within a trial period; and (3.) being complete and requiring a purchase for operation or use.

3. The computer-implemented method of claim 1, wherein the selection of the at least one icon is affected by clicking a button.

4. The computer implemented method of claim 3, wherein the selection of the at least one icon is affected by clicking a mouse button.

5. The computer implemented method of claim 4, wherein the selection of the at least one icon is affected by clicking a mouse button when a cursor is positioned over a predefined area of the displayed information.

6. The computer implemented method of claim 1, wherein the selection of the at least one icon is affected by depressing a key on a key pad.

7. The computer implemented method of claim 1, wherein the selection of the at least one icon is affected by using a pointing device.

8. The computer implemented method of claim 1, wherein the selection of the at least one icon is affected by selection of a visually displayed indication.

9. The computer implemented method of claim 1, wherein the at least one icon comprises a visual image identifying at least one software application associated with the at least one icon.

10. The computer implemented method of claim 1, wherein the visual image of the icon comprises text identifying at least one software application associated with the at least one icon.

11. The computer implemented method of claim 1, further comprising:
enabling a user to select at least two icons to direct the computational device to delete at least two software applications associated with each selected icon;
enabling the user to direct the computational device to initiate deletion of the software applications associated with any selected icon; and
deleting all software applications or associated with the selected icons from the computational device.

12. The computer-implemented method of claim 11, wherein at least one software application is incomplete and requires additional instructions to be read into the computational device in order to at least partially be executed by the computational device.

13. The computer-implemented method of claim 12, wherein the at least one software application is incomplete and requires additional instructions to be downloaded from the computer network and read into the computational device in order to at least partially be executed by the computational device or wherein the at least one software application or communications network-enabling service software is complete and executable.

14. The computer-implemented method of claim 13, wherein the computer network comprises the Internet.

15. The computer-implemented method of claim 12, wherein the selection of the at least one icon is affected by clicking a button.

16. The computer implemented method of claim 15, wherein the selection of the at least one icon is affected by clicking a mouse button.

17. The computer implemented method of claim 16, wherein the selection of at least one icon is affected by clicking a mouse button when a cursor is positioned over a predefined area of the displayed information.

18. The computer implemented method of claim 12, wherein the selection of the at least one icon is affected by using a pointing device.

19. A computational apparatus comprising:
display means for providing a visual representation of a plurality of application icons, each icon having a one-to-one correspondence with at least one software application;
selection means for enabling a user to select at least one icon; and
control means for directing the computational device to delete the at least one software application associated with the selected icon from the computational device.

20. A computer-readable media comprising software-encoded instructions that direct an information technology system to practice the method of claim 1.
